(19) United States
(12) Patent Application Publication
(10) Pub. No.: US 2011/0016084 A1
(43) Pub. Date: Jan. 20, 2011

(54) DATA INTEGRATION BETWEEN PROJECT SYSTEMS

(75) Inventors: Kiran MUNDY, Lexington, MA (US); Tianyi WANG, Mountain View, CA (US); Mary SUN, Los Altos, CA (US); Sivakumar SUNDARESAN, Union City, CA (US); Simon BALL, San Francisco, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: ORACLE INTERNATIONAL CORPORATION, Redwood Shores, CA (US)

(21) Appl. No.: 12/503,472

(22) Filed: Jul. 15, 2009

(51) Int. Cl. G06F 17/30

(52) U.S. Cl. 707/613; 707/E17.005

(57) ABSTRACT

A project systems integrator integrates a financial planning system and an operational planning system for a project. The integrator loads a work breakdown structure (“WBS”) from the financial planning system and another WBS from the operational planning system. The integrator then records links between corresponding nodes of the financial WBS and operational WBS. When data is entered, updated, or otherwise changed, the data is propagated between the nodes in accordance with the links.

### FIELD OF THE INVENTION

One embodiment is directed generally to project management and accounting, and more particularly to data integration between project management and accounting systems.

### BACKGROUND INFORMATION

Companies frequently use separate systems for project management and project accounting. The integration of data between these systems is important for accurate financial reporting of cost and revenue and, in cases where billing is part of the accounting system, for accurate and timely billing. There is no clear standard on how the data should be stored in the accounting system versus the project management system. The two systems are frequently implemented separately and managed separately. Thus, a project in the accounting system may look completely different from a project in the management system.

This disparity leads to challenges when companies attempt to integrate data from the two systems. One approach often taken is to synchronize and maintain an identical hierarchical work breakdown structure (“WBS”) on both sides with the aim of making the data integration easier. This is a difficult work-around and often dangerous as the WBS structure can typically be modified in either system. Synchronizing these changes in order to make the data integration work can be difficult and may also be a counter-productive.

### SUMMARY OF THE INVENTION

One embodiment is a system for integrating a financial planning system and an operational planning system for a project. The system loads a work breakdown structure (“WBS”) from the financial planning system and another WBS from the operational planning system. The system then records links between corresponding nodes of the financial WBS and operational WBS. When data is entered, updated, or otherwise changed, the data is propagated between the nodes in accordance with the links.

### BRIEF DESCRIPTION OF THE DRAWINGS

FIG. 1 is a block diagram of a system that can implement a project systems integrator in accordance with an embodiment.

FIG. 2 illustrates an example work breakdown structure.

FIG. 3 illustrates project planning platform in accordance with an embodiment.

FIG. 4 illustrates an example work breakdown structure linking in accordance with an embodiment.

FIG. 5 illustrates another work breakdown structure linking in accordance with an embodiment.

FIG. 6 illustrates a flow diagram of the function of a project systems integrator in accordance with an embodiment.

### DETAILED DESCRIPTION

An embodiment is directed to a project systems integrator that establishes links between a work breakdown structure (“WBS”) from both the financial planning and operational planning applications of a project planning platform. Recognizing that the two systems may be disparate, the project system integrator establishes links between individual tasks in each WBS and propagates data from one system to the other based on these links. Accordingly, the entire WBS does not need to be extracted or propagated and recreated at the other system, nor do the WBS structures have to be identical. When a change or progress update is recorded for a task in one system, that data is propagated to the corresponding task of the other system. Thus, an efficient integration and synchronization of the two systems is achieved.

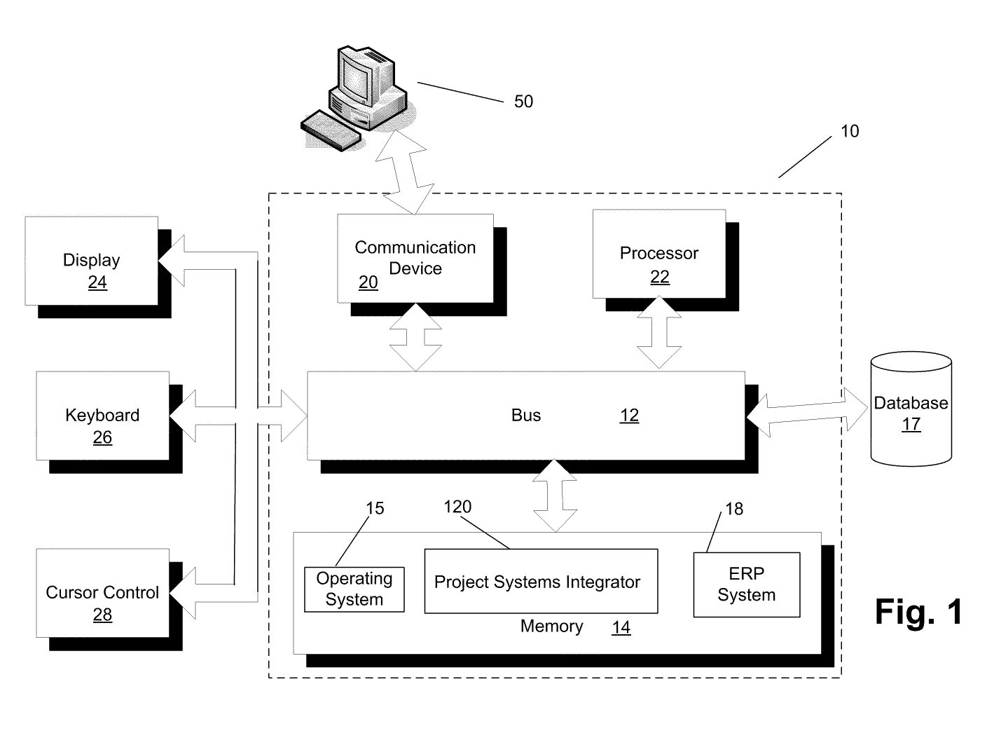

FIG. 1 is a block diagram of a system 10 that can implement an embodiment of a project systems integrator. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network (such as the Internet) or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a project systems integrator 120. This module is described in greater detail below. The modules may include enterprise resource planning (“ERP”) modules 18 of an ERP system that may interact with project systems integrator 120. An ERP system is a computer system that integrates several data sources and processes of an organization into a unified system. A typical ERP system uses multiple components of computer software and hardware to achieve the integration. A unified ERP database 17, coupled to bus 12, is used to store data for the various system modules. In one embodiment, ERP modules 18 are part of the “Oracle E-Business Suite Release 12” ERP system from Oracle Corp. In other embodiments, project systems integrator 120 may be a stand-alone system and not integrated with an ERP system, or may be part of any other integrated system. In some embodiments, the functionality of project systems integrator 120, are directed and utilized remotely from a user's computer 50 through communication device 20.

A work breakdown structure (“WBS”) in project management and systems engineering is a tool used to define and group a project's discrete work elements (or “tasks”) in a way that helps organize and define the total work scope of the project. A WBS element may be a product, data, service, or any combination. The WBS also provides the necessary framework for detailed cost estimating and control along with providing guidance for schedule development and control. Additionally, the WBS is a dynamic tool and can be revised and updated as needed by the project manager.

The WBS is typically a tree structure that shows a subdivision of effort required to achieve an objective, for example, a program, project, or contract. In a project or contract, the WBS is developed by starting with the end objective and successively subdividing it into manageable components in terms of size, duration, and responsibility (e.g., systems, subsystems, components, tasks, subtasks, and work packages), all of which include steps to achieve the objective. The WBS provides a common framework for the natural development of the overall planning and control of a contract and is the basis for dividing work into definable increments from which the statement of work can be developed and technical, schedule, cost, and labor hour reporting can be established. A WBS permits the summing or “rolling up” of subordinate costs for tasks, materials, etc., into their successively higher level “parent” tasks, materials, etc. For each element of the work breakdown structure, a description of the task to be performed is generated.

A well-designed WBS makes it easy to assign each project activity to one and only one terminal element of the WBS. In addition to its function in cost accounting, the WBS also helps map requirements from one level of system specification to another, for example a requirements cross reference matrix mapping functional requirements to high level or low level design documents.

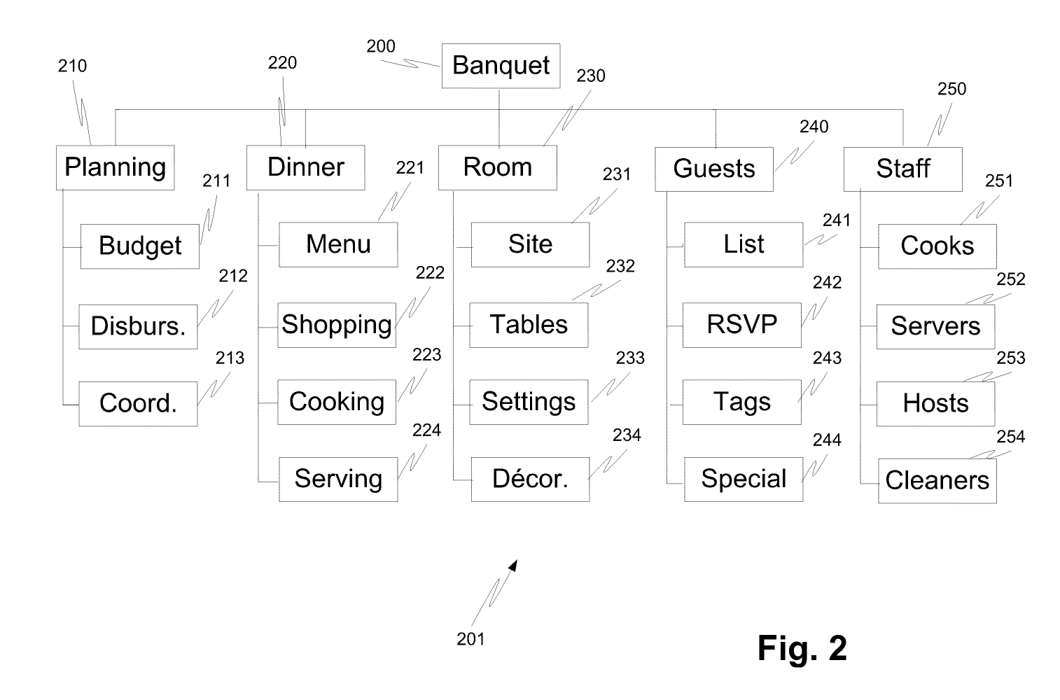

FIG. 2 illustrates an example WBS 201 for a banquet project 200. The banquet project 200 is broken down into five tasks: a planning task 210, a dinner task 220, a room task 230, a guests task 240, and a staff task 250. Planning task 210 is further subdivided into budget task 211, disbursements task 212, and coordination task 213. Dinner task 220 is further subdivided into menu task 221, shopping task 222, cooking task 223, and serving task 224. Room task 230 is further subdivided into site task 231, tables and chairs task 232, place setting task 233, and decorations task 234. Guests task 240 is further subdivided into guest list task 241, RSVPs 242, name tags 243, and special needs 244. Staff task is further subdivided into cooks 251, servers 252, hosts 253, and cleaners 254. Using WBS 201 to compartmentalize the tasks to be accomplished, individual progress and costs may be monitored for each task.

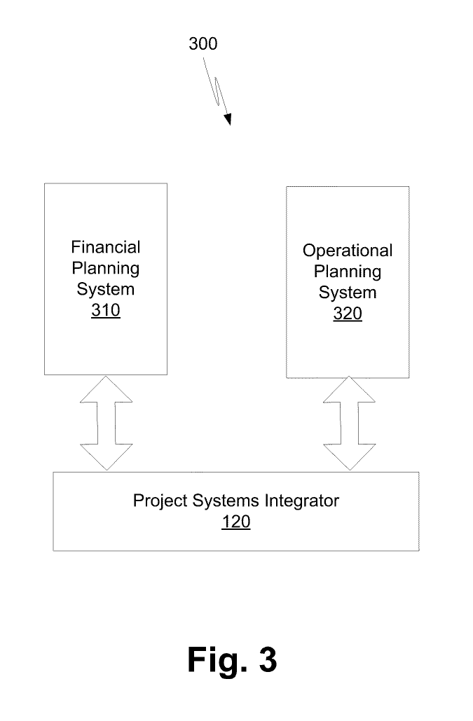

A WBS is used in both financial planning and operational planning for a project. FIG. 3 illustrates a project planning platform 300 in accordance with an embodiment. Project platform 300 comprises a financial planning system 310 including features to manage projects costs, manage assets, calculate revenue accrual and adjustments, manage budgeting and forecasting, and manage contract billing and adjustments. Financial planning system 310 also allows project managers and team members to provide operational project management, review and adjust project progress, monitor costs, and record progress. In one embodiment, financial planning system 310 is “Project Management” from Oracle Corp., which may be part of an ERP system.

Project platform 300 further includes an operational planning system 320 including features that allow project managers, team members, and schedulers to provide operation project management, manage day-to-day staffing, monitor cost schedules, review works schedules, record progress, and develop schedules. In one embodiment, operational planning system 320 is “Primavera P6 Enterprise Project Portfolio Management” from Oracle Corp. Project systems integrator 120 maintains links between financial planning system 310 and operational planning system 320 so that changes or updates in their respective WBSs are propagated to the other system. These links maintained by project systems integrator 120 facilitate harmony between the financial planning system 310 and operational planning system 320 without the need of replicating the entire WBS of one system in the other system, as only the updated/changed data is transmitted.

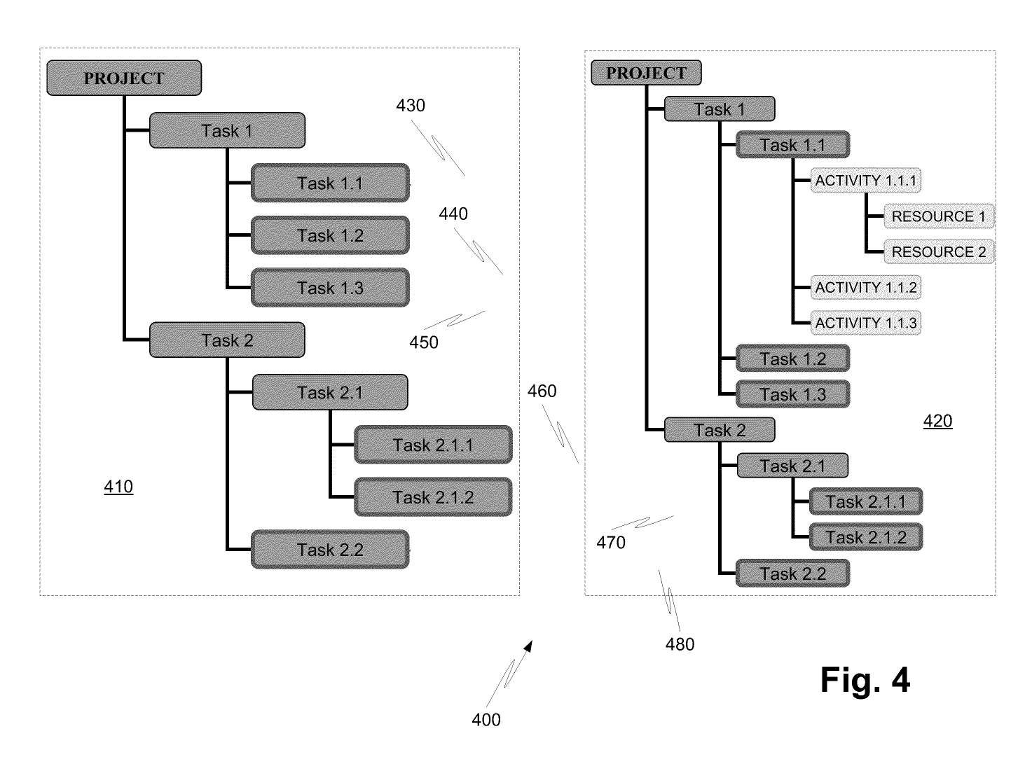

FIG. 4 illustrates a logical diagram of an example WBS linking scheme 400 maintained by project systems integrator 120 in accordance with an embodiment. Financial WBS 410 is maintained by financial planning system 310 and operational WBS 420 is maintained by operational planning system 320. In example scheme 400, the WBS structures are substantially similar in that both WBS 410 and 420 have two tasks at the first level (task 1 and task 2), five tasks at the second level (tasks 1.1,1.2, 1.3, 2.1, and 2.2), and two tasks at the third level (task 2.1.1 and 2.1.2). However, there is no requirement that linked WBSs have a similar structure, as linking occurs at the individual task level rather than as a whole. Further, one WBS may be at a higher level than the other WBS. For example, operational WBS 420 breaks task 1.1 into activities 1.1.1, 1.1.2, and 1.1.3, as well as resources 1 and 2, whereas financial WBS 410 does not include that level of specificity. Activities 1.1.1, 1.1.2, and 1.1.3, as well as resources 1 and 2 are considered work plan that is not relevant to the financial planning.

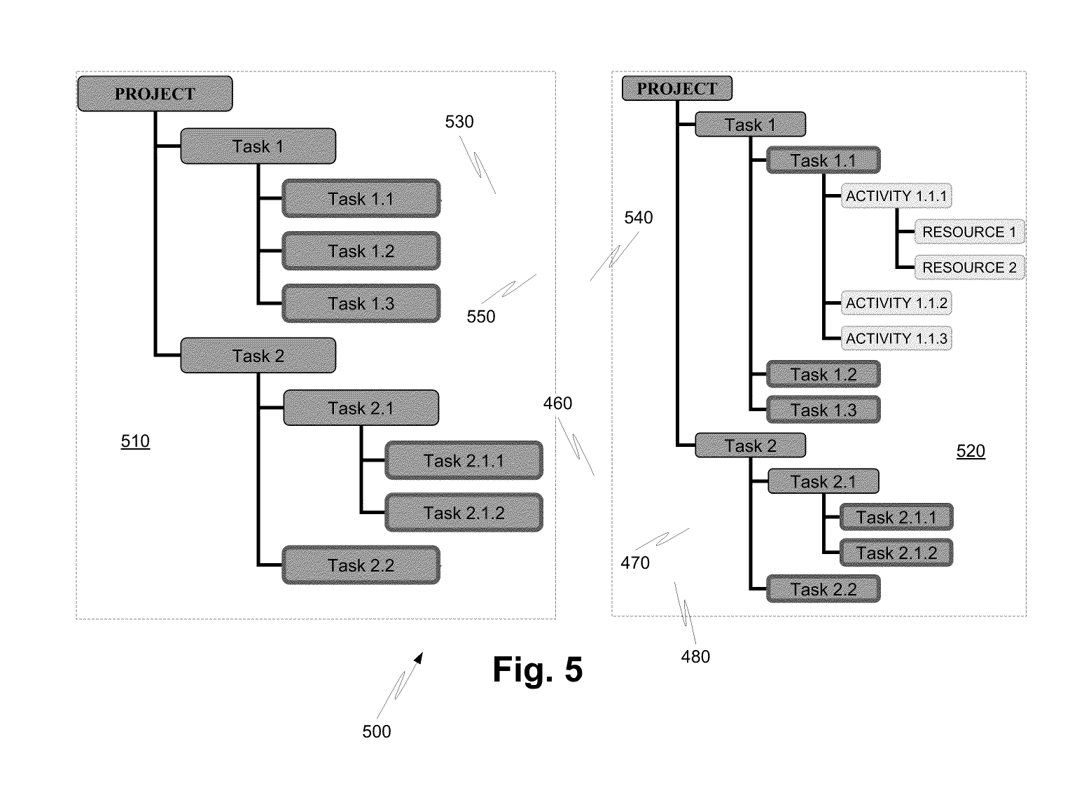

In this example, financial WBS 410 and operational WBS 420 are linked by six links between tasks maintained by project systems integrator 120. Link 430 links task 1.1 of financial WBS 410 to task 1.1 of operational WBS 420. Similarly, links 440, 450, 460, 470, and 480 link tasks in financial WBS 410 to corresponding tasks in operational WBS 420. The linking may be a one-to-one correspondence or many-to-one correspondence. For example, FIG. 5 illustrates a WBS linking scheme 500 similar to linking scheme 400; however, linking scheme 500 includes many-to-one links 530, 540, 550 between task 1 of financial WBS 510 and tasks 1.1,1.2, and 1.3 of operational WBS 520, respectively. In this example, the tasks 1.1,1.2, and 1.3 of operational WBS 520 may be rolled up into task 1 of financial WBS 510. In one embodiment, the links are stored in database 17.

In one embodiment, financial planning system 310 is selected to be the source system and operational planning system 320 is selected to be the target system for specific types of data to be propagated. For example, data entered regarding resource definitions and availability, budgets, and incurred costs for a task are entered in financial planning system 310 and propagated to operational planning system 320 by project systems integrator 120 based on a linking scheme (e.g., linking scheme 400). However, data entered regarding resource assignments and demand, estimates at completion of total hours and costs, scheduled activities, incurred hours, expense reports, cost of work done, and the percent completion of the task may be entered in operational planning system 320 and propagated to financial planning system 310 by project systems integrator 120 based on the linking scheme. In one embodiment, the propagation for each type of data is one-way to preserve data integrity.

In another embodiment, data propagation between linked tasks may be two-way. For example, data regarding project definition and structure, such as project attributes, team members, change management, and WBS tasks and activities, may be entered in either system and propagated. However, in two-way data propagation, the links are one-to-one.

The tables below provide some example of linking schemes. Table 1 lists the tasks (IDs 101-102) and corresponding task names for financial planning system 310. Table 2 lists the tasks (IDs 300-302) and corresponding tasks name for operational planning system 320. Table 3 lists three link schemes (one-to-one, many-to-one, and many-to-many), with each scheme have a mapping ID, and the corresponding linked financial task ID and operational system task ID.

TABLE 1
Financial System Tasks Table

| Financial Task ID | Task Name |
|---|---|
| 101 | Menu |
| 102 | Shopping |

TABLE 2
Operational System Task Table

| Operational Task ID | Task Name |
|---|---|
| 300 | Finalize Menu Items |
| 301 | Break out Ingredients |
| | List |
| 302 | List Quantities needed |

TABLE 3

| | | |
|---|---|---|
| | | Operational System Task |
| Mapping ID | Financial Task ID | ID |

One-to-One Links

| | | |
|---|---|---|
| 1 | 101 | 300 |

Many Operational Tasks Mapping to One Financial Task

| | | |
|---|---|---|
| 1 | 101 | 300 |
| 2 | 101 | 301 |
| 3 | 101 | 302 |

Many Operational Tasks Mapping to Many Financial Tasks

| | | |
|---|---|---|
| 1 | 101 | 300 |
| 2 | 101 | 301 |
| 3 | 101 | 302 |
| 4 | 102 | 302 |

In one embodiment, the links for propagating data from financial planning system 310 to operational planning system 320 uses a Service-Oriented Architecture (“SOA”) such as Fusion SOA 11G from Oracle Corp., and Web Services as a transport mechanism. In another embodiment, the data is propagated using Data Integration from Oracle Corp. as an integration technology, which is extract, load and transform (“ELT”) based for integration at the database level. In various embodiments, data propagation between systems 310 and 320 may occur substantially instantaneously, on-demand, or periodically.

In one embodiment, links between WBSs 410 and 420 may be changed as often as needed. When a link is changed, data for the current period (where data is stored based on a period) may be cleared and recreated based on the new link. Data for prior periods is not affected. Alternatively, the link changes may be designated to only affect new data entered.

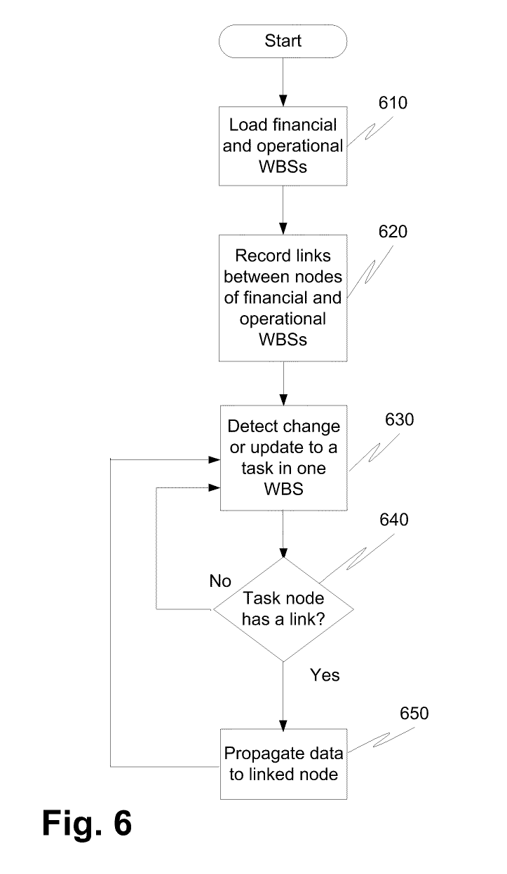

FIG. 6 illustrates a flow diagram of the functionality of project systems integrator 120 in accordance with an embodiment. In one embodiment, the functionality of the flow diagram of FIG. 6 is implemented by software stored in memory and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Project systems integrator 120 loads WBS data structures 410, 420 from financial planning system 310 and operational planning system 310 (610). In one embodiment, each WBS data structure 410, 420 is a tree data structure, wherein each task in WBS data tree data structures 410,420 is a node in the tree. In response to user input, project systems integrator 120 records links between nodes of WBS data structures 410,420 (620) as selected by the user. In one embodiment, one node of the link is selected as the source node and one node is selected as the target node. In another embodiment, data flows each way so that the linked nodes are sources and targets to each other. When project details are changed, or progress is updated, project systems integrator 120 detects a change to a task node (630). If that task node is a node for which a link is recorded between WBS data structures 410, 420 (640), project systems integrator 120 propagates the changed or updated data to the other node in the link (650). Functionality continues to 630 where the next change or update is detected.

Project systems integrator 120 is implemented in one embodiment for an engineering, construction, aerospace or defense project where, typically, the high level deliverable breakdown (i.e., what is to be accomplished) is defined in financial planning system 310 and the detailed breakout of the work plan (i.e., how it is to be accomplished) is defined in operational planning system 320. In this embodiment, the entire WBS of financial planning system 310 may be propagated over links to operational planning system 320 at the outset. Links are automatically established from the lowest level nodes in financial planning system 310 to their counterparts in operational planning system 320. Any subsequent detailed breakout of the lowest level nodes done in operational planning system 320 does not affect the WBS tree in financial planning system 310. Progress data and scheduling from operational planning system 320, at the linked level, is transmitted across to financial planning system 310.

In embodiments where the project is initially created in operational planning system 320 (e.g., as an estimate that forms the basis for a proposal), levels of the WBS tree may be marked by the user to indicate that everything above that level should transmit across to financial planning system 310. The marking may be established based on which levels represent deliverables that need to be included in the proposal and be subsequently reported. Links may be automatically established from the marked nodes to their counterparts created in financial planning system 310.

In another embodiment, financial planning system 310 is used for an expanded flow typical for engineering and construction companies. In an expanded flow, the cost of construction is calculated using a “cost breakdown structure” and the actual costs and progress needs to be tracked against this structure. However, construction is actually performed using an “execution breakdown structure” and these companies likely need to be able to monitor progress against the execution structure as well. Instead, in one embodiment, these companies can create a WBS in operational planning system 320 and a WBS in financial planning system 310 and create one-to-one links between the two.

In another embodiment, for engineer-to-order and maintenance companies, a WBS can first be created in financial planning system 310 based on work orders and bills of material created in a manufacturing system. The WBS can then be transmitted across to operational planning system 320 for scheduling. Links may be automatically established at the lowest level nodes on financial planning system 310, which in this case would also correspond to lowest level nodes in operational planning system 320. Rescheduled dates would be sent back to financial planning system 310 along the linked nodes.

Accordingly, a project systems integrator including a linking structure between the WBSs of financial and operational planning systems is disclosed. Links are established between specific tasks in the WBS of the financial planning system and the operational planning system. Data entered in one system is automatically propagated to the other system regarding the corresponding tasks without the need to transmit or replicated the entire WBS of the source system in the target system. Therefore, complicated logic is not required to keep the structures synchronized. The data integration problem is accordingly divorced from whatever level of WBS integration is chosen. Furthermore, unlike prior systems, data structures on both sides may be completely different if needed. Also, this system is more flexible, allowing a user to safely change the data node links as desired through the life of the project.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A computer-readable medium having instructions stored thereon that, when executed by a processor, cause the processor to integrate a financial planning system and an operational planning system for a project by:
loading a first work breakdown structure (WBS) from the financial planning system;
loading a second WBS from the operational planning system;
recording at least one link between a first node in the first WBS and a second node in the second WBS; and
propagating data between the first node and the second node via the link.

2. The computer-readable medium of claim 1, wherein data entered into the financial planning system at the first node is propagated to the second node.

3. The computer-readable medium of claim 1, wherein data entered into the operational planning system at the second node is propagated to the first node.

4. The computer-readable medium of claim 1, further comprising recording a plurality of links linking a plurality of nodes in the first WBS and a plurality of nodes in the second WBS.

5. The computer-readable medium of claim 4, wherein the plurality of links are many-to-one.

6. The computer-readable medium of claim 4, wherein the plurality of links are one-to-one.

7. The computer-readable medium of claim 1, wherein the data flows in a one-way direction from the first node to the second node, and the data comprises at least one of: resource definition data, resource availability data, and budget data.

8. The computer-readable medium of claim 1, wherein the data flows in a one-way direction from the second node to the first node, and the data comprises at least one of: resource assignment data, resource demand data, estimated hours at completion data, estimated cost at completion data, cost of work done data, and percent completed data.

9. The computer-readable medium of claim 1, wherein the data flows in a two-way direction between the first node and the second node.

10. The computer-readable medium of claim 1, wherein the at least one link is changed to link the first node to a third node in the second WBS.

11. A computer-implemented method for integrating a financial planning system and an operational planning system for a project, comprising:
loading a first work breakdown structure (WBS) from the financial planning system;
loading a second WBS from the operational planning system;
recording at least one link between a first node in the first WBS and a second node in the second WBS; and
propagating data between the first node and the second node in accordance with the link.

12. The method of claim 11, wherein data entered into the financial planning system at the first node is propagated to the second node.

13. The method of claim 11, wherein data entered into the operational planning system at the second node is propagated to the first node.

14. The method of claim 11, wherein the data flows in a one-way direction from the first node to the second node, and the data comprises at least one of: resource definition data, resource availability data, and budget data.

15. The method of claim 11, wherein the data flows in a one-way direction from the second node to the first node, and the data comprises at least one of: resource assignment data, resource demand data, estimated hours at completion data, estimated cost at completion data, cost of work done data, and percent completed data.

16. A system for integrating a financial planning system and an operational planning system for a project, comprising:
a financial planning system having a first work breakdown structure (WBS);
an operational planning system having a second WBS; and
a project systems integrator that records at least one link between a first node in the first WBS and a second node in the second WBS and propagates data between the first node and the second node in accordance with the link.

17. The system of claim 16, wherein the link comprises a web service.

18. The system of claim 16, wherein the link comprises extract, load and transport integration.

19. The computer-readable medium of claim 1, wherein the first node and second node are tasks.

20. The computer-readable medium of claim 1, wherein the data comprises changed data from the first WBS or the second WBS.
